(19) United States
(12) Patent Application Publication
(10) Pub. No.: US 2025/0219316 A1
(43) Pub. Date: Jul. 3, 2025

(54) Charging Flap System With Opening Device for a Vehicle

(71) Applicant: Bayerische Motoren Werke Aktiengesellschaft, Muenchen (DE)

(72) Inventor: Thomas ROTH, Eching (DE)

(21) Appl. No.: 18/850,649

(22) PCT Filed: Oct. 9, 2023
(86) PCT No.: PCT/EP2023/077817

§ 371 Date: Sep. 25, 2024

(30) Foreign Application Priority Data
Oct. 10, 2022 (DE) 10 2022 126 153.0

(51) Int. Cl. H01R 13/447; E05F 15/63

(52) U.S. Cl. CPC H01R 13/447; E05F 15/63; E05Y 2900/534; H01R 2201/26

(57) ABSTRACT

An electrically operable charging flap system for a vehicle, in particular for an electric vehicle, includes a holding element for fastening in a vehicle, a charging flap fastener, which is movably fastened to the holding element, for fastening a charging flap, in order to move the charging flap to and fro between an open position and a closed position by way of an electric motor, and an opening device which is arranged on the charging flap fastener and is designed for manual raising of the charging flap fastener before the fastening of the charging flap. During installation, the holding element is fastened in the vehicle, and the charging flap fastener is raised manually into an open position. The charging flap is then fastened to the charging flap fastener while the charging flap fastener, after being raised manually, is in the open position.

### BACKGROUND AND SUMMARY

The invention relates to a charging flap system for a vehicle, in particular for an electric vehicle. The invention furthermore relates to a method for assembling a charging flap system in a vehicle, and to a vehicle.

The invention is in particular suitable for use in electrically powered vehicles in which an external electrical energy source such as, for example, a charging station, is connected to the vehicle in order to charge the latter with electricity as an energy source which is stored in an electric accumulator of the vehicle.

However, the invention can also be used in vehicles with internal combustion engines, for example, in which a fuel as an energy source is supplied to the vehicle for example at a gas station. The invention can also be used for hybrid vehicles in which an external energy source is connected to the vehicle in order to charge or fuel the latter with electric energy and/or a fuel, respectively.

Charging flap systems, or fuel flap systems, respectively, of this type typically have a pivotable charging flap or closure flap which is opened for filling the vehicle with an energy source such as, for example, an electric current or another type of fuel for powering the vehicle motor/engine, and after filling is closed again in order to seal a connector or filling unit disposed therebehind, or to protect the latter in relation to external influences, respectively.

Known charging flap systems often have a charging flap which opens mechanically. In the process, the charging flap is opened by means of a push-push system, wherein a user pushes against the closed charging flap from the outside. Opening of the charging flap by way of a spring system is effected as a result. A hinge arm to which the charging flap is fastened is ejected by way of the push-push function.

In electric charging flap systems there is a motor which is provided for driving the charging flap so as to open and close the latter. Here, there is no push-push system, because opening and closing of the charging flap is effected by a corresponding signal that causes the motor to be energized. When assembling the charging flap system in the vehicle, a problem arises due to the fact that the hinge arm must be in its opened position in order for the charging flap to be assembled on the hinge arm. The assembling procedure is heavily restricted as a result, this requiring an increased expenditure in terms of time and resulting in disrupted logistics processes.

It is an object of the invention to provide an electrically operated charging flap system, or fuel flap system, respectively, and to provide an assembling method which enables improved assembling of the charging flap system in the vehicle and a reduction in expenditure in terms of assembly time and costs.

In order to achieve this object, the invention provides an electrically operable charging flap system for a vehicle, in particular for an electric vehicle, comprising: a holding element for fastening in a vehicle; a charging flap fastener, which is movably fastened to the holding element, for fastening a charging flap so as to move the charging flap in a reciprocating manner between an opened position and a closed position by way of an electric motor; and an opening device which is disposed on the charging flap fastener and is designed for manually pulling open the charging flap fastener prior to fastening the charging flap.

As a result, an operator on the line can open the charging flap fastener and install the charging flap on the external side of the charging flap fastener during production of the vehicle in the factory, without the electric motor already having to be connected to the power supply for opening and closing the charging flap system for this purpose. As a result, disruptions in the logistics process which, to date, are being caused by the assembly requirements of the charging flap on the charging flap fastener are avoided. Assembly is facilitated and can take place more rapidly, so that costs are saved.

The opening device preferably comprises an engagement structure, formed on the charging flap fastener, for pulling by hand and/or for mutually engaging with an assembling aid.

The opening device advantageously comprises at least one projecting element.

The opening device advantageously comprises a depression.

The opening device advantageously comprises a pulling tab.

The opening device advantageously comprises one or a plurality of engagement openings.

The charging flap fastener preferably comprises a pivotable hinge arm with a charging flap support, the opening device being disposed, and the charging flap being able to be assembled, on the external side of the latter.

According to one aspect of the invention, a method for assembling an electrically operable charging flap system is provided, comprising the following steps:
providing an electrically operable charging flap system, comprising a holding element for fastening in a vehicle, and a charging flap fastener, which is movably fastened to the holding element, for fastening a charging flap so that the latter is able to be moved during operation between a closed position and an opened position via an electric motor;
fastening the holding element in the vehicle;
manually pulling open the charging flap fastener from a closed position to an opened position; and
fastening the charging flap to the charging flap fastener while the charging flap fastener is in the opened position after having been manually pulled open.

For manually pulling open the charging flap fastener, or prior thereto, engaging in an engagement structure which is formed on the external side of the charging flap fastener takes place manually and/or by means of an assembling aid.

A self-locking action of the electric motor is advantageously overcome when manually pulling open the charging flap fastener.

A coupling device which is disposed between the electric motor and the charging flap fastener is preferably separated for manually pulling open the charging flap fastener, or prior thereto.

The charging flap is preferably fastened to the external side of the charging flap fastener.

The fastening of the holding element to the vehicle preferably takes place prior to manually pulling open the charging flap fastener.

A connector element for establishing an electrical connection to an external charging station is advantageously assembled on the holding element.

Assembling the connector element on the holding element preferably takes place prior to manually pulling out the charging flap fastener.

An electrically operable charging flap system which is designed according to the invention is preferably used in the method.

According to a further aspect, a vehicle, in particular an electric vehicle, which comprises an electrically operated charging flap system according to the invention, is provided.

Advantages and details which are disclosed above and also hereunder in the context of the charging flap system according to the invention also apply to the method according to the invention, and vice versa.

A preferred exemplary embodiment of the invention will be explained in more detail hereunder by means of drawings.

### BRIEF DESCRIPTION OF THE DRAWINGS

FIG. 1 shows an electrically operable charging flap system according to a first preferred embodiment of the invention, prior to assembling the charging flap, as an oblique perspective view onto its front side;

FIG. 2 shows an electrically operable charging flap system according to a second preferred embodiment of the invention, prior to assembling the charging flap, as an oblique perspective view onto its front side;

FIG. 3 shows the electrically operable charging flap system according to FIG. 1 or FIG. 2, as an oblique perspective view onto its rear side, prior to assembling the charging flap;

FIG. 4 shows the electrically operable charging flap system according to FIG. 1 or FIG. 2 as an oblique perspective view onto its rear side, during assembling of the charging flap; and

FIG. 5 shows the electrically operable charging flap system according to FIG. 1 or FIG. 2 as an oblique perspective view onto its rear side, after assembling the charging flap.

In the figures, elements which are identical or correspond to one another are in each case identified with the same reference signs and are therefore not described again unless this appears to be expedient. The disclosures present in the entire description are correspondingly applicable to parts having identical reference signs or identical component designations.

The terms “front”, “rear”, etc., refer to the state of the charging flap system installed in the vehicle, when viewed proceeding from the external side of the vehicle toward the vehicle interior. These terms may also refer to the charging flap system per se, when viewed proceeding from its front side, or external side, in the direction of its rear side, or internal side, and beyond.

### DETAILED DESCRIPTION OF THE DRAWINGS

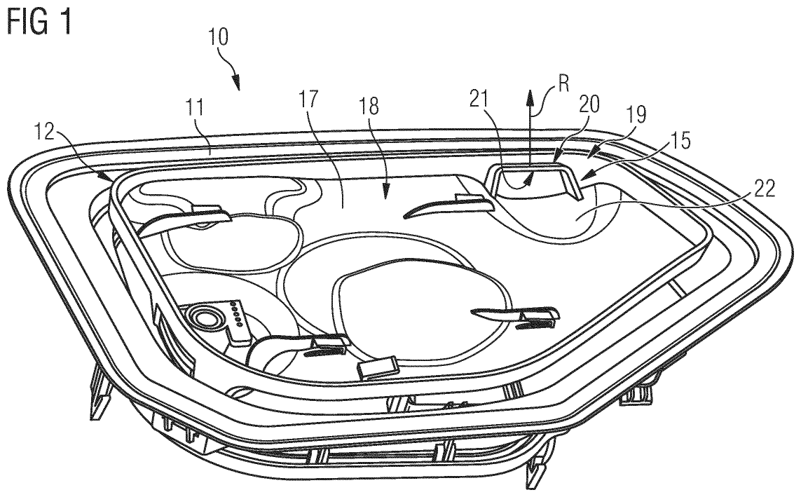

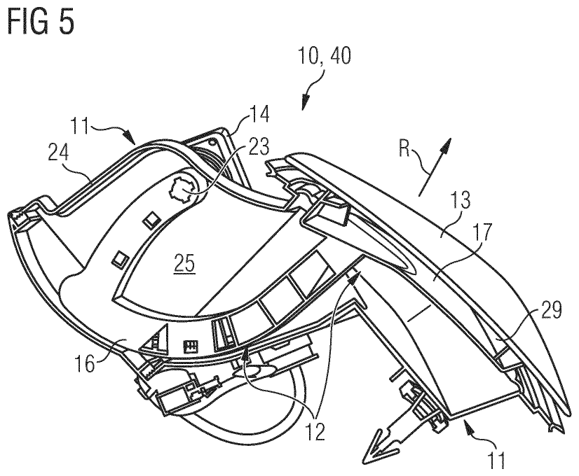

A first preferred embodiment of the invention will be described by means of FIGS. 1 and 4. FIG. 1 herein shows an electrically operable charging flap system 10 for a vehicle. The charging flap system 10 comprises a holding element 11 which is designed for fastening in the vehicle. A charging flap fastener 12 is movably fastened to the holding element 11.

The charging flap fastener 12 is designed for assembling a charging flap 13 on the movable charging flap fastener 12 in such a way that the charging flap 13 is able to be moved in a reciprocating manner between an opened position and a closed position by means of an electric motor 14 (see FIG. 4).

The holding element 11 in this example is designed as a charging pot. It is designed for fastening in an outer body element of the vehicle.

An opening device 15, which is designed to enable the charging flap fastener 12 to be manually pulled open prior to fastening the charging flap 13, is disposed on the charging flap fastener 12 (see FIG. 1).

The charging flap fastener 12 comprises a hinge arm 16 with a charging flap support 17. The hinge arm 16 is pivotably fastened to the holding element, or the charging pot 11, respectively. The charging flap support 17 is disposed or designed on the hinge arm 16. The charging flap 13 is able to be fastened to the front side, or external side 18, of the charging flap support 17, which also forms the external side of the charging flap fastener 12, or of the hinge arm 16, respectively (see FIG. 4).

In the example shown here, the opening device 15, which is likewise disposed on the front side 18 of the charging flap support 17, comprises an engagement structure 19. The latter is designed to enable engaging and pulling thereon by hand, or using one or a plurality of fingers of a hand, and to in this way manually pull open the charging flap fastener 12, or the hinge arm 16, respectively. The engagement structure 19 thus enables engaging by hand or using the fingers in order to pull open the hinge arm 16.

For this purpose, the engagement structure 19 comprises an engagement element 20 which, in the manner of a bridge, projects from the charging flap support 17 in the direction of the charging flap 13 to be fastened, wherein the engagement element bridges a sub-region of the charging flap support 17 at a distance from the front side 18 of the latter. The rear side of the engagement element 20, which is disposed opposite the front side 18 of the charging flap support 17, forms an activation surface 21 which enables at least one finger of the hand to engage therebehind or thereon. As a result, a force acting in the opening direction R of the hinge arm 16 can be exerted by pulling on the activation surface 21. The projecting engagement element 20 in this way forms a pulling tab.

The engagement structure 19 furthermore comprises a depression 22 which is formed in the charging flap support 17, on the front side 18 thereof in the region of the engagement element 20, and by way of a sub-region extends below the latter.

As is shown in FIG. 4, the electric motor 14 serves to drive the hinge arm 16 and is coupled to the latter in such a way that the hinge arm 16 performs a pivoting movement about its pivot 23 in order to move the hinge arm 16, conjointly with the charging flap 13 fastened thereto, to an opened or closed position. The hinge arm 16 that connects the charging flap support 17 to the pivot 23 is formed, or curved multiple times, in the manner of a gooseneck.

Furthermore provided is a hinge box 24, the interior space 25 thereof serving to completely receive the hinge arm, or gooseneck 16, when the charging flap 13, which is fastened to the hinge arm 16, is closed by retracting or inwardly pivoting the hinge arm 16.

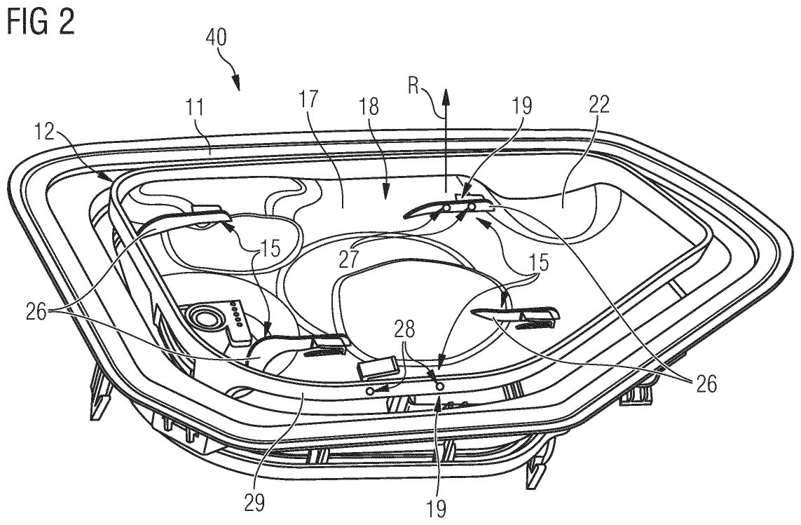

FIG. 2 shows a charging flap system 40 according to a second preferred embodiment of the invention. In this example, the opening device 15 comprises a plurality of projecting rib elements 26 which are disposed on the front side 18 of the charging flap support 17. The rib elements 26 form pulling ribs, or engagement surfaces, for gripping the rib element between two fingers and for manually pulling on the charging flap support 17.

Engagement structures 19 in the form of holes 27 are preferably disposed in the rib elements 26. The holes 27 extend through at least one of the rib elements 26, substantially parallel to the front side 18, or perpendicularly to the opening direction R of the hinge arm 16, respectively.

Further holes 28 are disposed in a peripheral region 29 of the charging flap support 17 that on the lateral edges of the front side 18 protrudes perpendicularly to the latter. The holes 28 likewise form engagement structures 19 and extend through the peripheral region 29, likewise substantially parallel to the front side 18, or perpendicularly to the opening direction R of the hinge arm 16, respectively. The engagement structures 19 with the holes 27, 28 serve for engaging a tool or assembling aid, wherein the holes 27, 28 come to mutually engage with the latter, and subsequently the charging flap fastener 12 by means of a tensile force applied manually on the tool in the opening direction R is pulled to the opened position.

An engagement element 20, as is shown in the first embodiment according to FIG. 1, is not provided in the second embodiment shown in FIG. 2. However, it is also additionally possible as an option here.

In terms of all further features and details, the charging flap system 40 according to the second embodiment is designed like the charging flap system 10 according to the first embodiment described above, as is shown in FIGS. 1 and 4, reference being made thereto herewith.

In all embodiments shown here, a coupling device, which is not visible in the figures, can also be disposed between the electric motor 14 and the charging flap fastener 12, or the hinge arm 16, respectively, so that the hinge arm 16 can easily be moved by separating the coupling device when the hinge arm 16 is being manually pulled open.

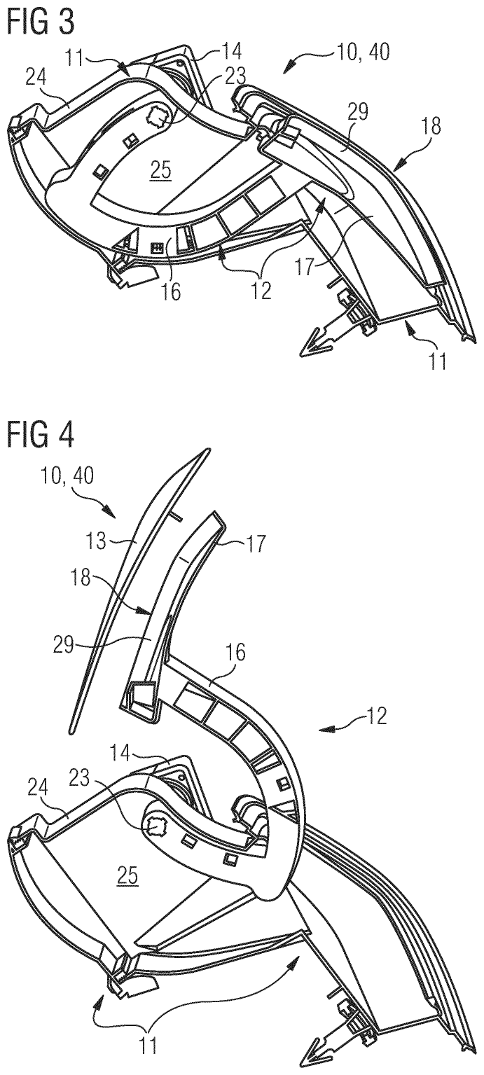

A method for assembling an electric, or an electrically driven, charging flap system is described hereunder by means of FIGS. 3 to 5. The charging flap system is in particular designed as described above.

In this example, an electrically operable charging flap system 10 or 40 is first provided. As described above, the latter comprises the holding element 11 for fastening in a vehicle, and the charging flap fastener 12 which is movably fastened to the holding element 11 (cf. FIGS. 1, 2) and which is preferably designed as a hinge arm 16 (cf. FIG. 4).

The hinge arm 16 is designed for fastening a charging flap 13 in such a way that the latter during operation is able to be moved between a closed position and an opened position by means of the electric motor 14.

The charging flap system 10 is now assembled in the vehicle. In the process, the holding element 11 and a connector element, not visible in the figures, for connecting an external energy source are assembled in the vehicle. The connector element is in particular designed for connecting an electric charging station.

Manually pulling open the hinge arm 16 by means of the opening device 15 described above now takes place, wherein the hinge arm 16 is moved, for example, from the closed position (cf. FIG. 3) to an opened position (cf. FIG. 4). The electric motor 14 is still non-energized in this phase of assembly. The hinge arm 16 cannot yet be electrically opened.

When pulling open the hinge arm 16 by hand and/or by means of an assembly aid, engaging in the engagement structure 19 takes place, for example, the latter being designed in particular as in the examples described above and being disposed on the external side 18 of the hinge arm 16, or of the charging flap support 17, respectively.

A self-locking action of the electric motor 14 is overcome when pulling open, or opening, the hinge arm 16.

However, a coupling device can also be disposed between the electric motor 14 and the charging flap fastener, or the hinge arm 16, respectively, so that the hinge arm 16 can easily be moved by separating the coupling device.

After manually pulling open the hinge arm 16 to the opened position, the charging flap 13 is fastened to the hinge arm 16. Fastening the charging flap 13 is performed on the external side 18 of the hinge arm 16, or of the charging flap support 17, respectively (cf. FIG. 4).

Assembling the holding element 11 in the vehicle takes place in particular before pulling open the hinge arm 16 and fastening the charging flap 13 to the hinge arm 13. Assembling the holding element 11 and the connector element in the vehicle takes place in particular in the direction from the vehicle interior to the vehicle exterior. In principle however, a sequence of the assembling steps that differs from that described above is also possible.

Thereafter, the hinge arm 16 with the charging flap 13 assembled thereon is moved back to the closed position again (cf. FIG. 5).

### LIST OF REFERENCE SIGNS

10, 40 Charging flap system
11 Holding element
12 Charging flap fastener
13 Charging flap
14 Electric motor
15 Opening device
16 Hinge arm
17 Charging flap support
18 Front side, or external side, of the charging flap support
19 Engagement structure
20 Engagement element
21 Activation surface
22 Depression
23 Pivot
24 Hinge box
25 Interior space
26 Rib elements
27, 28 Holes
29 Peripheral region
R Opening direction

1.-10. (canceled)

11. An electrically operable charging flap system for a vehicle, comprising:
a holding element for fastening in a vehicle;
a charging flap fastener, which is movably fastened to the holding element, for fastening a charging flap so as to move, via an electric motor, the charging flap in a reciprocating manner between an open position and a closed position; and
an opening device which is disposed on the charging flap fastener and is configured for manually pulling open the charging flap fastener prior to fastening the charging flap.

12. The charging flap system according to claim 11, wherein
the opening device comprises an engagement structure, formed on the charging flap fastener, for pulling by hand and/or for mutually engaging with an assembling aid.

13. The charging flap system according to claim 11, wherein the opening device comprises:
(i) at least one projecting element; and/or
(ii) a depression; and/or
(iii) a pulling tab; and/or
(iv) one or a plurality of engagement openings for an assembly aid.

14. The charging flap system according to claim 11, wherein
the charging flap fastener comprises a pivotable hinge arm with a charging flap support, the opening device being disposed, and the charging flap being able to be assembled, on an external side of the charging flap support.

15. A method for assembling an electrically operable charging flap system, the method comprising the steps of:
a) providing an electrically operable charging flap system comprising a holding element for fastening in a vehicle, and a charging flap fastener, which is movably fastened to the holding element, for fastening a charging flap so that the charging flap is able to be moved during operation between a closed position and an open position via an electric motor;
b) fastening the holding element in the vehicle;
c) manually pulling open the charging flap fastener to the open position; and
d) fastening the charging flap to the charging flap fastener while the charging flap fastener is in the open position after having been manually pulled open.

16. The method according to claim 15, wherein:
(i) in step c), engaging in an engagement structure which is formed on an external side of the charging flap fastener takes place manually and/or by use of an assembling aid; and/or
(ii) in step c), a self-locking action of the electric motor is overcome, or prior to step c), a coupling device which is disposed between the electric motor and the charging flap fastener is separated; and/or
(iii) in step d), the charging flap is fastened to the external side of the charging flap fastener.

17. The method according to claim 15, wherein step b) is carried out prior to steps c) and d).

18. The method according to claim 16, wherein
(i) a connector element for establishing an electrical connection to an external charging station is assembled on the holding element; or
(ii) prior to steps c) and d), a connector element for establishing an electrical connection to an external charging station is assembled on the holding element.

19. The method according to claim 16, further comprising:
electrically operating the charging flap system.

20. A vehicle comprising an electrically operated charging flap system according to claim 11.

21. The vehicle according to claim 20, wherein the vehicle is an electric vehicle.
